(19) United States
(12) Patent Application Publication
(10) Pub. No.: US 2005/0287999 A1
(43) Pub. Date: Dec. 29, 2005

(54) Network support for customized call forwarding

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 10/877,607

(22) Filed: Jun. 25, 2004

(51) Int. Cl. H04M 3/42

(52) U.S. Cl. 455/417

(57) ABSTRACT

Embodiments of the system and method allow a mobile terminal to customize call forwarding requests. The method may have the steps of: sending, from a terminal, a call forwarding customizing request to the network that initiates forwarding of calls from one phone number to another phone number; verifying, by the network, authorized access for the terminal to the call forwarding functionality for the requested phone number; instructing, by the network, the terminal to enter appropriate data having defined parameters for the call forwarding customizing request; begin forwarding calls, by the network, from the one phone number to the another phone number as defined by the terminal; and continuing to forward calls until the call forwarding is canceled by the terminal or until the call forwarding is cancelled according to the defined parameters.

### TECHNICAL FIELD

The present invention relates generally to telecommunication, and in particular to providing a feature that allows a mobile subscriber to customize call forwarding requests.

### BACKGROUND OF THE INVENTION

Wireless communication systems are constantly evolving. System designers are continually developing greater numbers of features for both service providers as well as for the end users. In the area of wireless phone systems, cellular based phone systems have advanced tremendously in recent years. Wireless phone systems are available based on a variety of modulation techniques and are capable of using a number of allocated frequency bands. Available modulation schemes include analog FM and digital modulation schemes using Time Division Multiple Access (TDMA) or Code Division Multiple Access (CDMA). Each scheme has inherent advantages and disadvantages relating to system architecture, frequency reuse, and communications quality. However, the features the manufacturer offers to the service provider and which the service provider offers to the consumer are similar between the different wireless systems.

Regardless of the modulation scheme in use, the wireless phone available to the end user has a number of important features. Nearly all wireless phones incorporate at least a keyboard for entering numbers and text, and a display that allows the user to display text, dialed numbers, pictures and incoming caller numbers. Additionally, wireless phones may incorporate electronic phonebooks, speed dialing, single button voicemail access, and messaging capabilities, such as e-mail.

The features described above present only a sample of features that are capable of, or have already been, implemented into wireless phone systems. Any individual feature is capable of implementation into some or all of the wireless systems using the modulation schemes mentioned above.

Mobile subscribers are becoming increasingly connected to their mobile handsets which are often viewed as a necessary accessory during waking hours, Also, the line between work life and personal life is increasingly blurred due to the workplace demands on many employees, combined with longer hours, flex-time schedules, etc. However, many times a user is not able to use his mobile terminal, for example, and must forward his calls to another number.

Call forwarding is a service feature, available in some switching systems, whereby calls can be rerouted automatically from one line, i.e., station number, to another or to an attendant. Call forwarding may be implemented in many forms.

This service enables the user, who is absent or cannot answer a call for other reasons, to forward the incoming calls to some other previously defined number or to a voice message answering machine. The service user or the exchange operator may define the user number to which the call is forwarded. In the prior art the following calls cannot be forwarded: wake-up calls, testing calls and operator-assisted calls. There are several known possibilities for call forwarding, but the only active one is the one that is defined last. Unfortunately, the user has very little control over the call forwarding feature.

Because of these and other issues, there is a need in telecommunications networks for a feature that allows a mobile subscriber to customize call forwarding requests.

### SUMMARY

The invention in one implementation encompasses a system. One embodiment of the system may have: a terminal operatively connected to a network; a call forwarding customizing request from the terminal that initiates, by the network, forwarding of calls from one phone number to another phone number; a call controller operatively connected to a call forwarding module; and the call forwarding module operatively connected to a database that stores defined parameters.

Another implementation of the present invention encompasses a method that may have the steps of: sending, from a terminal, a call forwarding customizing request to the network that initiates forwarding of calls from one phone number to another phone number; verifying, by the network, authorized access for the terminal to the call forwarding functionality for the requested phone number; instructing, by the network, the terminal to enter appropriate data having defined parameters for the call forwarding customizing request; begin forwarding calls, by the network, from the one phone number to the another phone number as defined by the terminal; and continuing to forward calls until the call forwarding is canceled by the terminal or until the call forwarding has expired according to the defined parameters.

### BRIEF DESCRIPTION OF THE DRAWINGS

Features of exemplary implementations of the invention will become apparent from the description, the claims, and the accompanying drawings in which:

FIG. 1 depicts a block diagram that illustrates elements of a system according to one embodiment for providing a feature that allows a mobile subscriber to customize call forwarding requests.

FIG. 2 illustrates a very general flow chart of logical operational steps that may be followed in accordance with one embodiment of the present method and system.

### DETAILED DESCRIPTION

The particular values and configurations discussed in these non-limiting examples can be varied and are cited merely to illustrate an embodiment of the present invention and are not intended to limit the scope of the invention.

Embodiments of the present system and method allow a mobile subscriber to customize call forwarding requests. The forwarding request may be for all calls to be forwarded to the mobile or it could be for a subset of calls. Additionally, the forwarding request may have date/time parameters defined such that between certain hours, the calls should be forwarded, or for a certain number of days the forwarding request should be in effect, etc. Thus, a new service is provided to wireless subscribers that gives them the ability to remotely initiate a call forwarding function such that the forwarding request takes into account such information as:

1) Should all calls be forwarded or only calls for a defined set of incoming numbers?

2) Should the request be in effect for a specific time period of the day only?

3) How long should the request be in effect?

4) Is this a reoccurring request that should go into and out of effect automatically?

Although the present system and method may be used with any type of network (wired and wireless, for example), a subscriber may typically be a mobile subscriber who uses a mobile terminal (also referred to as mobile phone, a cell phone, mobile handset, or car phone).

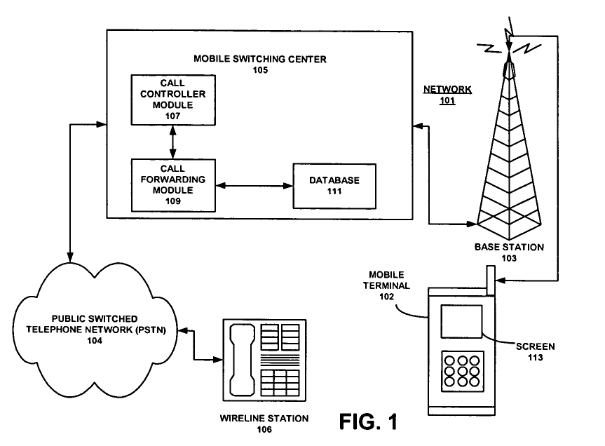

In the FIG. 1 embodiment a network 101 is operatively connected to at least one mobile terminal 102. As is known the network 101 may have at least one base station 103, which is operatively connected to a mobile switching center 105, wirelessly coupled to the mobile terminal 102. The mobile switching center 105 in the network 101 may also have a call control module 107 operatively connected to base station 103 and to a call forwarding module 109. A database 111 may also be operatively connected to the caller/called identification module 109.

The network 101 may be, or may be part of, one or more of a telephone network, a local area network (“LAN”), the Internet, and a wireless network. In the depicted embodiment, a public switched telephone network (PSTN) 104 is connected to the mobile switching center 105. The PSTN 104 routes calls to and from mobile users through the mobile switching center 105. The PSTN 104 also routes calls from and to wireline stations 106. The PSTN 104 generally may be implemented as the worldwide voice telephone network accessible to all those with telephones and access privileges (e.g., AT&T long distance network).

The call forwarding module 109 allows a mobile subscriber to customize call forwarding requests. A forwarding request, received by the call controller module 107 from the mobile terminal 102, may be for all calls to be forwarded to the mobile or it could be for a subset of calls. Additionally, the forwarding request may have date/time parameters defined such that between certain hours, the calls should be forwarded, or for a certain number of days the forwarding request, should be in effect, etc. This information and instructions may be stored in the database 111.

A customized call forwarding request may be initiated by entering a key sequence (e.g. *899) from the mobile terminal 102 or with the press of a soft key on the mobile terminal 102, for example. The network (the call forwarding module 102) may respond to the request by prompting for the customized information from the mobile subscriber. For example; date/time—this request should go into effect, date/time—this request should expire, is this a repeating event, what number should calls be forwarded to, etc. This information may be stored in the network in the subscriber database 111, for example.

Then, when a call comes in for the mobile subscriber, the call controller module 102 may query the subscriber database 111 before connecting the call to see if a call forwarding scenario is in effect according to the subscriber's defined parameters. If call forwarding is in effect, the call controller module 109 may access the forwarding number stored in the subscriber database 111 and set up a call to the forwarding number.

Any call forwarding request put into effect by a mobile subscriber may be verified or authenticated with a password protection scheme. For example, such a scheme may be similar to how accessing voicemail messages is protected with a password.

The call forwarding module may store information in the subscriber database and that information may consist of the following types of data parameters:

1. Customized Call Forwarding Feature Purchased—Y/N

2. Customized Call Forwarding Feature Enabled—Y/N

3. Date Request Should Go Into Effect—MM/DD/YYYY

4. Date Request Should Expire—MM/DD/YYYY

5. Time Request Should Go Into Effect—HH:MM:SS

6. Time Request Should Expire—HH:MM:SS

7. Forward All Incoming Calls—Y/N

8. Forwarding Number for All Calls

9. Incoming Numbers to Forward to Associated Forwarding Number—Array of up to 10 incoming numbers associated to 1 or more forwarding numbers, for example

10. Is this a repeating event—Y/N

11. Repeat Days

12. Repeating Times

In one embodiment of the present system and method, a mobile subscriber initiates an instruction to the network (in the form of a soft key, or a dialed number sequence, for example) to instruct it to forward calls from one number to another phone number. Pending verification of authorized access to this functionality for the requested number, the subscriber may be instructed to enter the appropriate data to customize the request (For example, all calls, specific calls, date/time in effect, repeating event, etc.). The network may then begin forwarding calls from the specified number to another number as defined by the subscriber. Calls that were forwarded may be identified to the forwarded number with a unique identifier. For example, if calls are forwarded to a mobile, incoming calls to the mobile that were forwarded, may be identified as such with display 113 on the mobile terminal 102 or using an alternate ring tone on the mobile terminal 102. The network may keep the forwarding in effect until the forwarding is canceled by the subscriber or until the defined parameters for time/date or repeating have expired.

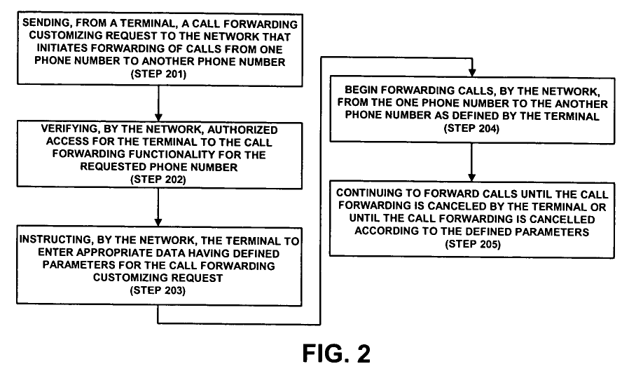

Referring to FIG. 2, one embodiment is depicted of a method for allowing a mobile terminal to customize call forwarding requests. Such an embodiment may have the following steps: sending, from a terminal, a call forwarding customizing request to the network that initiates forwarding of calls from one phone number to another phone number (step 201); verifying, by the network, authorized access for the terminal to the call forwarding functionality for the requested phone number (step 202); instructing, by the network, the terminal to enter appropriate data having defined parameters for the call forwarding customizing request (step 203); begin forwarding calls, by the network, from the one phone number to the another phone number as defined by the terminal (step 204); and continuing to forward calls until the call forwarding is canceled by the terminal or until the call forwarding has expired according to the defined parameters (step 205).

In one embodiment of such an example, a mobile subscriber initiates an instruction to the network (in the form of a soft key, or a dialed number sequence, for example) to instruct it to forward calls from one number to another phone number. Pending verification of authorized access to this functionality for the requested MIN number, the subscriber may be instructed to enter the appropriate data to customize their request (For example, all calls; specific calls, date/time in effect, repeating event, etc.). The network may then begin forwarding calls from the specified number to another number as defined by the subscriber. Calls that were forwarded may be identified to the forwarded number with a unique identifier. For example, if calls are forwarded to a mobile terminal, incoming calls to the mobile that were forwarded, may be identified as such with an appropriate display to the mobile terminal or using an alternate ring tone. The network may keep the forwarding in effect until the forwarding is canceled by the subscriber or until the defined parameters for time/date or repeating expired.

Embodiments of the present system and method provide a methodology that allows a subscriber to customize a call forwarding request such that it is possible to:

1) Forward all calls made to a specified phone to another number until the request is discontinued;

2) Forward only specific calls that come in to a specified phone over to another number until the request is discontinued;

3) Forward calls made to a specified number over to another number for specific time periods of the day (e.g. all calls between 8:30 am to 4:30 pm);

4) Forward calls made to a specified number over to another number until a specific date in the future; and

5) Forward calls made to a specified number over to another number for a repeating schedule (e.g. Every Friday until Dec. 31, 2004).

Thus embodiments of the present system and method fulfill a need in the prior art for allowing a mobile subscriber to customize call forwarding requests.

The present system and method may be used with non-mobile phones and terminals, as well as, mobile phones and mobile terminals. Also, different types of data storage devices may be used with the present method and system. For example, a data storage device may be one or more of a magnetic, electrical, optical, biological, and atomic data storage medium.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. A method for allowing a mobile terminal to customize call forwarding requests, comprising the steps of:
sending, from a terminal, a call forwarding customizing request to the network that initiates forwarding of calls from one phone number to another phone number;
verifying, by the network, authorized access for the terminal to the call forwarding functionality for the requested phone number;
instructing, by the network, the terminal to enter appropriate data having defined parameters for the call forwarding customizing request;
begin forwarding calls, by the network, from the one phone number to the another phone number as defined by the terminal; and
continuing to forward calls until the call forwarding is canceled by the terminal or until the call forwarding is cancelled according to the defined parameters.

2. The method according to claim 1, wherein the terminal is a mobile terminal.

3. The method according to claim 1, wherein the call forwarding customizing request is in the form of at least one of a soft key, a dialed number sequence, and a voice input command.

4. The method according to claim 1, wherein the predetermined parameters are indicative of at least one of: forward all calls made to a specified phone number to another phone number until the request is discontinued; forward only specific calls that come in to a specified phone number over to another phone number until the request is discontinued; forward calls made to a specified phone number to another phone number for specific periods of the time; forward calls made to a specified phone number to another phone number until a specific date in the future; and forward calls made to a specified phone number to another phone number according to a repeating schedule.

5. The method according to claim 1, wherein the defined parameters define at least one of forwarding calls for all calls, specific calls, specified date/time, and repeating event.

6. A system that allows a mobile terminal to customize call forwarding requests, comprising:
a terminal operatively connected to a network;
a call forwarding customizing request from the terminal that initiates, by the network, forwarding of calls from one phone number to another phone number;
a call controller operatively connected to a call forwarding module; and
the call forwarding module operatively connected to a database that stores defined parameters;
wherein upon sending, from the terminal, a call forwarding customizing request the network initiates forwarding of calls from one phone number to another phone number; authorized access is verified for the terminal to the call forwarding functionality for the requested phone number; the terminal is instructed to enter appropriate data having defined parameters for the call forwarding customizing request; the network begins forwarding calls from the one phone number to the another phone number as defined by the terminal; and the network continues to forward calls until the call forwarding is canceled by the terminal or until the call forwarding is cancelled according to the defined parameters.

7. The system according to claim 6, wherein the terminal is a mobile terminal.

8. The system according to claim 6, wherein the call forwarding customizing request is in the form of at least one of a soft key, a dialed number sequence, and a voice input command.

9. The system according to claim 6, wherein the predetermined parameters are indicative of at least one of: forward all calls made to a specified phone number to another phone number until the request is discontinued; forward only specific calls that come in to a specified phone number to another phone number until the request is discontinued; forward calls made to a specified phone number to another phone number for specific time periods of the time; forward calls made to a specified phone number to another phone number until a specific date in the future; and forward calls made to a specified phone number to another phone number for a repeating schedule.

10. The system according to claim 6, wherein the defined parameters define at least one of forwarding calls for all calls, specific calls, specified date/time, and repeating event.

11. A method for allowing a mobile terminal to customize call forwarding requests, comprising the steps of:
sending, from a terminal, a call forwarding customizing request to the network that initiates forwarding of calls from one phone number to another phone number;
verifying, by the network, authorized access for the terminal to the call forwarding functionality for the requested phone number;
instructing, by the network, the terminal to enter appropriate data having defined parameters for the call forwarding customizing request;
begin forwarding calls, by the network, from the one phone number to the another phone number as defined by the terminal; and
continuing to at least one of, forwarding all calls made to a specified phone number to another phone number until the request is discontinued; forwarding only specific calls that come in to a specified phone number over to another phone number until the request is discontinued; forwarding calls made to a specified phone number to another phone number for specific periods of the time; forwarding calls made to a specified phone number to another phone number until a specific date in the future; and forward calls made to a specified phone number to another phone number according to a repeating schedule.

12. The method according to claim 11, wherein the terminal is a mobile terminal.

13. The method according to claim 11, wherein the call forwarding customizing request is in the form of at least one of a soft key, a dialed number sequence, and a voice input command.

14. The method according to claim 11, wherein the predetermined parameters are indicative of at least one of: forward all calls made to a specified phone number to another phone number until the request is discontinued; forward only specific calls that come in to a specified phone number over to another phone number until the request is discontinued; forward calls made to a specified phone number to another phone number for specific periods of the time; forward calls made to a specified phone number to another phone number until a specific date in the future; and forward calls made to a specified phone number to another phone number according to a repeating schedule.

15. The method according to claim 11, wherein the defined parameters define at least one of forwarding calls for all calls, specific calls, specified date/time, and repeating event.

16. The method according to claim 11, wherein the defined parameters are stored in a subscriber database.

17. The method according to claim 11, wherein the defined parameters include at least one of:
Customized Call Forwarding Feature Purchased—Y/N;
Customized Call Forwarding Feature Enabled—Y/N;
Date Request Should Go Into Effect—MM/DD/YYYY;
Date Request Should Expire—MM/DD/YYYY;
Time Request Should Go Into Effect—HH:MM:SS;
Time Request Should Expire—HH:MM:SS;
Forward All Incoming Calls—Y/N;
Forwarding Number for All Calls;
Incoming Numbers to Forward to Associated Forwarding Number—Array of up to 10 incoming numbers associated to 1 or more forwarding numbers, for example
Is this a repeating event—Y/N;
Repeat Days; and
Repeating Times.

18. The method according to claim 11, wherein calls that are forwarded to a mobile terminal are identified to the forwarded number with a unique identifier.

19. The method according to claim 11, wherein the unique identifier is at lest one of a graphic image and a text image on a display of the mobile terminal.

20. The method according to claim 11, wherein the unique identifier is an alternate ring tone that is emitted by the mobile terminal.
